(19) United States
(12) Patent Application Publication
(10) Pub. No.: US 2025/0170815 A1
(43) Pub. Date: May 29, 2025

(54) LAMINATING SYSTEM AND STORAGE MEDIUM

(71) Applicant: KONICA MINOLTA, INC., Tokyo (JP)

(72) Inventor: Yusuke TERAI, Tokyo (JP)

(73) Assignee: KONICA MINOLTA, INC., Tokyo (JP)

(21) Appl. No.: 18/955,684

(22) Filed: Nov. 21, 2024

(30) Foreign Application Priority Data
Nov. 28, 2023 (JP) 2023-200833

(51) Int. Cl. B32B 41/00; B32B 37/00

(52) U.S. Cl. CPC B32B 41/00; B32B 37/003

(57) ABSTRACT

A laminating system includes: an image former that forms an image on a sheet; a laminator that is provided on a downstream side of the image former and performs a lamination process of laminating the sheet with a film; and a hardware processor that performs, before execution of a job, a test lamination process of causing the laminator to laminate a sheet with no image formed or a sheet with a test image formed by the image former, the test image being different from an image of the job.

### BACKGROUND OF THE INVENTION

### Technical Field

The present invention relates to a laminating system and a storage medium.

### Description of Related Art

Conventionally, a laminating apparatus that covers a printed product with a transparent resin film has been used. For example, in Japanese Unexamined Patent Publication No. H 05-338039, there is disclosed a laminating apparatus that is connected to an image forming apparatus and laminates sheets sequentially conveyed from the upstream side with a film having an adhesive layer.

### SUMMARY OF THE INVENTION

However, in the lamination process in the conventional laminating apparatus, failure may occur due to wrinkling of the film or entering of air bubbles between the sheet and the film. Furthermore, if the cause of the failure in the lamination process is the state of the sheet after image formation (characteristics of the sheet or the like), the state of the film used in the lamination process, the environment in which the laminating apparatus is installed, or the like, the failure may occur continuously.

The present invention has been made in view of the above-described problems in the related art, and an object of the present invention is to provide a laminating system and a storage medium storing a program capable of preventing continuous occurrence of failure in a lamination process.

To achieve at least one of the abovementioned objects, according to an aspect of the present invention, a laminating system reflecting one aspect of the present invention
an image former that forms an image on a sheet;
a laminator that is provided on a downstream side of the image former and performs a lamination process of laminating the sheet with a film; and
a hardware processor that performs, before execution of a job, a test lamination process of causing the laminator to laminate a sheet with no image formed or a sheet with a test image formed by the image former, the test image being different from an image of the job.

According to an aspect of the present invention, a non-transitory computer-readable storage medium reflecting one aspect of the present invention stores a program causing, of a laminating system including an image former that forms an image on a sheet and a laminator that is provided on a downstream side of the image former and performs a lamination process of laminating the sheet with a film, a computer to:
perform, before execution of a job, a test lamination process of causing the laminator to laminate a sheet with no image formed or a sheet with a test image formed by the image former, the test image being different from an image of the job.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic configuration diagram of a laminating system according to an embodiment of the present invention;

FIG. 2 is a block diagram illustrating a functional configuration of the laminating system;

FIG. 3 is a diagram for explaining a process of superposing sheets at a superposing section;

FIG. 4 is a diagram illustrating a schematic configuration of a separator;

FIG. 5 is a flowchart illustrating a pre-job control process; and

FIG. 6 is a flowchart illustrating a test lamination process.

### DETAILED DESCRIPTION

Hereinafter, one or more embodiments of a laminating system and a storage medium storing a program according to the present invention will be described with reference to the drawings. However, the scope of the invention is not limited to the embodiments below or illustrated examples.

### [1. Configuration of Laminating System]

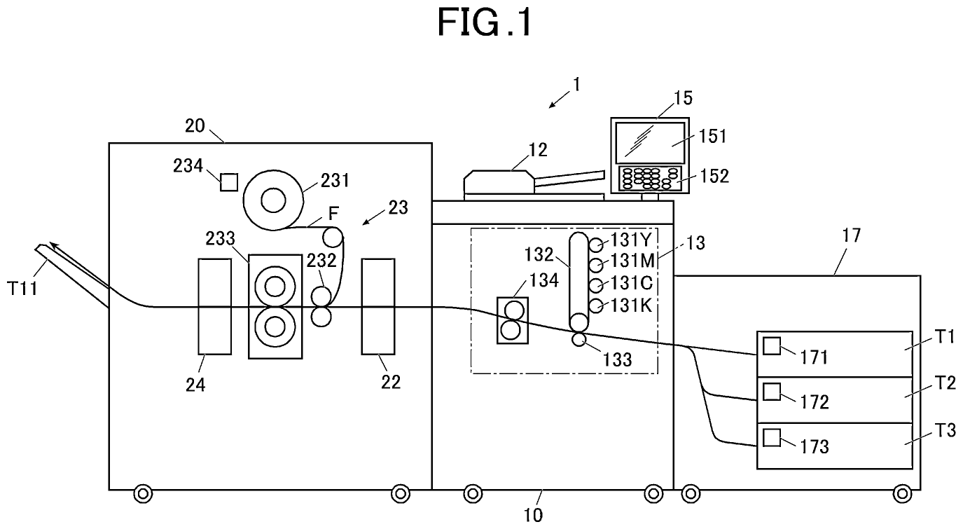

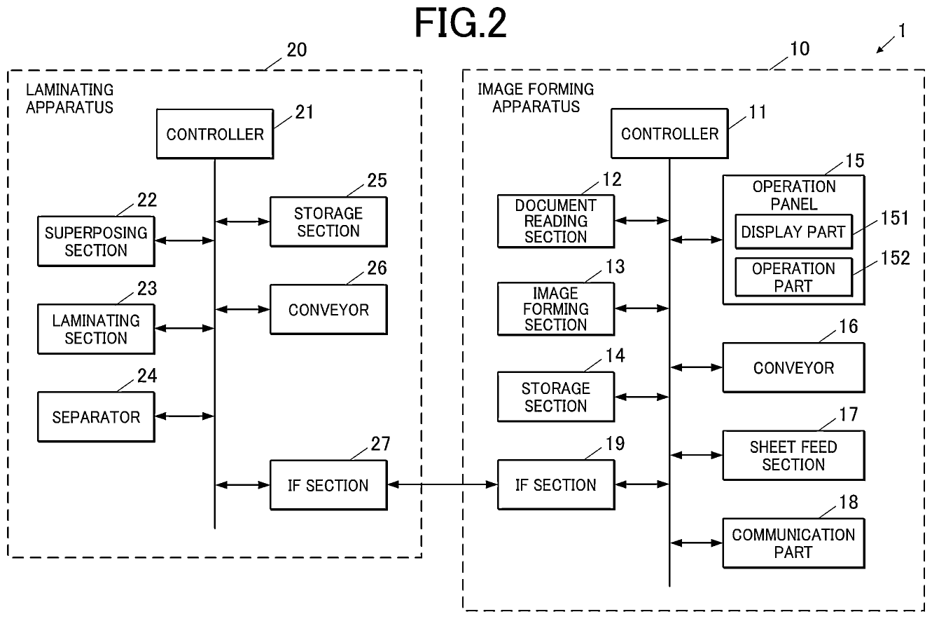

FIG. 1 is a schematic configuration diagram of a laminating system 1 according to the present embodiment. FIG. 2 is a block diagram showing a functional configuration of the laminating system 1. The laminating system 1 includes an image forming apparatus 10 and a laminating apparatus 20.

The image forming apparatus 10 forms an image on a sheet. The image forming apparatus 10 is connected to the laminating apparatus 20. The image forming apparatus 10 continuously delivers a plurality of sheets to the laminating apparatus 20.

The laminating apparatus 20 is provided on the downstream side of the image forming apparatus 10, and performs a lamination process on the sheet conveyed from the image forming apparatus 10.

### [1-1. Configuration of Image Forming Apparatus]

As illustrated in FIG. 2, the image forming apparatus 10 includes a controller 11 (hardware processor), a document reading section 12, an image forming section 13 (image former), a storage section 14, an operation panel 15, a conveyor 16, a sheet feed section 17 (sheet feeder), a communication part 18, an Interface (IF) section 19, and the like. The operation panel 15 includes a display part 151 (display) and an operation part 152.

The controller 11 includes a central processing unit (CPU), a random access memory (RAM), and the like. The CPU reads various programs stored in the storage section 14 in response to operation signals input from the operation part 152 and instruction signals received by the communication part 18 or the IF section 19. The CPU develops the read various programs in the RAM and integrally controls the operation of the image forming apparatus 10 in cooperation with the various programs developed in the RAM.

The document reading section 12 outputs image data obtained by reading an image of a document placed on a document plate or an auto document feeder (ADF) to the controller 11.

The image forming section 13 forms an image on a sheet supplied from the sheet feed section 17 by an electrophotographic method. The image forming section 13 forms an image on the basis of image data read by the document reading section 12 or image data received from an external apparatus.

As illustrated in FIG. 1, the image forming section 13 includes photosensitive drums 131Y, 131M, 131C and 131K corresponding to the respective colors of yellow, magenta, cyan and black, an intermediate transfer belt 132, a secondary transfer roller 133, a fixing section 134 (fixer), and the like.

The image forming section 13 uniformly charges the photosensitive drum 131Y, and then performs scanning and exposure with laser beams on the basis of yellow image data to form an electrostatic latent image on the surface of the photosensitive drum 131Y. Next, the image forming section 13 causes yellow toner to adhere to the electrostatic latent image on the photosensitive drum 131Y to perform development.

The photosensitive drums 131M, 131C and 131K are the same as the photosensitive drum 131Y except that the colors they treat are different from that of the photosensitive drum 131Y, and thus the description thereof will be omitted.

The image forming section 13 sequentially transfers the toner images of the respective colors formed on the photosensitive drums 131Y, 131M, 131C and 131K onto the intermediate transfer belt 132 (primary transfer). That is, the image forming section 13 forms a color toner image in which the toner images of the four colors are superimposed on top of one another on the intermediate transfer belt 132.

The image forming section 13 transfers the color toner image on the intermediate transfer belt 132 onto a sheet by the secondary transfer roller 133 (secondary transfer).

The image forming section 13 heats and pressurizes the sheet, on which the color toner image has been transferred, by the fixing section 134 to fix the color toner image to the sheet.

The storage section 14 is a nonvolatile storage device including a hard disk drive (HDD), a solid state drive (SSD), and/or the like. The storage section 14 stores various programs, various data, and the like.

The storage section 14 stores data of a color tone adjustment pattern image to be used for a color tone adjustment process for adjusting the color tone of an image to be formed by the image forming section 13.

In the color tone adjustment process, the controller 11 causes the image forming section 13 to form and output the color tone adjustment pattern image on a sheet. The controller 11 causes the document reading section 12 to read the color tone adjustment pattern image on the sheet, and adjusts, on the basis of the read image, the color tone in an image to be formed by the image forming section 13.

The storage section 14 stores test lamination information.

The test lamination information includes the type of a sheet and the coverage rate of an image formed on the sheet with no failure occurred in the test lamination process described later. Alternatively, the test lamination information includes characteristics of a sheet and the coverage rate of an image formed on the sheet with no failure occurred in a test lamination process described later.

The operation panel 15 includes the display part 151 that displays various types of information to a user and the operation part 152 that receives operation inputs from the user.

The display part 151 includes a color liquid crystal display or the like. The display part 151 displays various screens in accordance with display control signals input from the controller 11.

The operation part 152 includes a touch screen provided on the screen of the display part 151 and various hard keys arranged around the screen of the display part 151. The operation part 152 outputs, to the controller 11, operation signals based on user operations.

The conveyor 16 includes a plurality of roller pairs. The conveyor 16 conveys a sheet supplied from the sheet feed section 17 to the image forming section 13. The conveyor 16 conveys a sheet with an image formed by the image forming section 13 to the laminating apparatus 20.

The sheet feed section 17 includes sheet feed trays T1, T2 and T3 and medium detectors 171, 172 and 173. The sheet feed section 17 supplies sheets to the image forming section 13 from the sheet feed trays T1, T2 and T3. In the respective sheet feed trays T1, T2 and T3, sheets of a sheet type, size and the like predetermined for the respective sheet feed trays T1, T2 and T3 are stored.

After replacing the sheets stored in any of the sheet feed trays T1, T2 and T3, the user changes tray setting information on the sheet feed tray. The tray setting information includes, for example, the size of sheets, the type of sheets, the name of sheets, the basis weight of sheets, and the like. When the tray setting information is changed by the user, the controller 11 stores the changed tray setting information together with the time at which the change was made in the storage section 14 as a tray setting information change record.

The medium detector 171 detects the characteristics of sheets stored in the sheet feed tray T1, and outputs the detection result to the controller 11. The medium detector 172 detects the characteristics of sheets stored in the sheet feed tray T2, and outputs the detection result to the controller 11. The medium detector 173 detects the characteristics of sheets stored in the sheet feed tray T3, and outputs the detection result to the controller 11.

The characteristics of sheets include the size, thickness, basis weight, moisture percentage, stiffness, surface properties and electric resistance of sheets.

The communication part 18 is an interface that connects the image forming apparatus 10 to a communication network. The communication part 18 transmits and receives various data to and from an external apparatus connected to the communication network.

The IF section 19 is an interface for data transmission and reception between the image forming apparatus 10 and the laminating apparatus 20.

### [1-2. Configuration of Laminating Apparatus]

As illustrated in FIG. 2, the laminating apparatus 20 includes a controller 21, a superposing section 22, a laminating section 23 (laminator), a separator 24, a storage section 25, a conveyor 26, and an IF section 27.

The controller 21 includes a CPU, a RAM, and the like. The CPU reads various programs stored in the storage section 25 in response to instruction signals received from the image forming apparatus 10 by the IF section 27. The CPU develops the read various programs in the RAM, and integrally controls the operation of the laminating apparatus 20 in cooperation with the various programs developed in the RAM.

The superposing section 22 is provided on the upstream side of the laminating section 23 on a sheet conveyance path.

The superposing section 22 superposes leading ends and trailing ends of sheets (cut sheets) continuously conveyed from the image forming apparatus 10. Specifically, the superposing section 22 superposes the trailing end of a preceding sheet on the upper portion of the leading end of a subsequent sheet by a predetermined amount, and conveys the sheets continuous in a belt-like shape.

The superposing section 22 conveys sheets to the laminating section 23 in the state in which the leading ends and the trailing ends of the sheets are superimposed on one another.

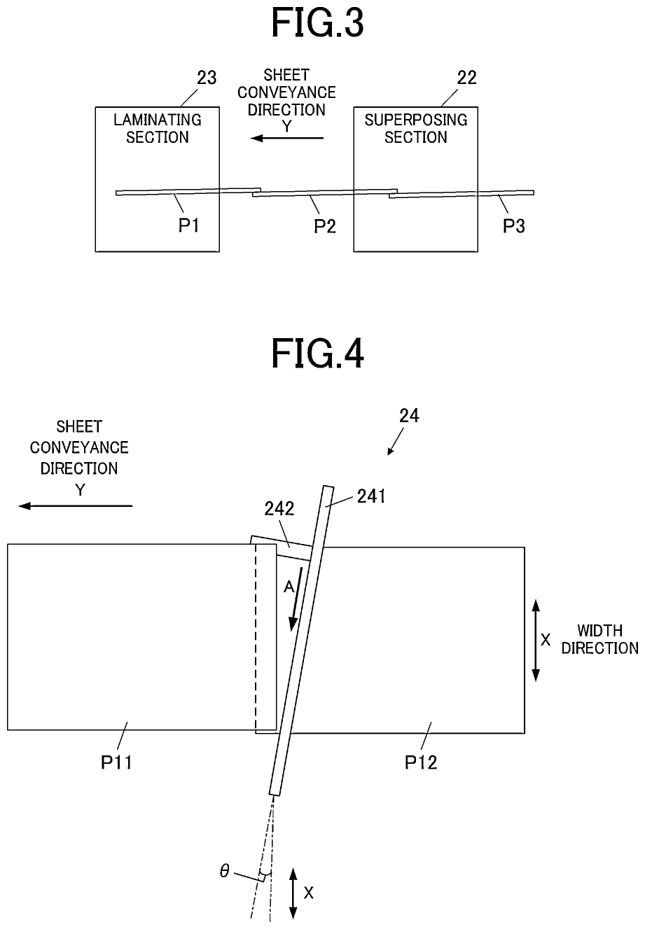

For example, as illustrated in FIG. 3, the superposing section 22 conveys sheets P1 and P2 such that the trailing end of the sheet P1 conveyed along a sheet conveyance direction Y is superposed on the upper portion of the leading end of the sheet P2 slightly (by a predetermined amount). Similarly, the superposing section 22 conveys the sheets P2 and P3 such that the trailing end of the sheet P2 is superposed on the upper portion of the leading end of the sheet P3. The superposing section 22 conveys the sheets P1 to P3 toward the laminating section 23.

The laminating section 23 overlays a film F (laminate film) having an adhesive layer on a plurality of sheets being conveyed. The laminating section 23 laminates the sheets with the film F. The laminating section 23 continuously applies the film F to the surface of the sheets superimposed by the superposing section 22.

The laminating section 23 includes a film roll 231, a bonding section 232, a lamination fixing section 233, and a film detector 234.

The film roll 231 is a roll around which the film F is wound in a roll shape. The film F has a transparent resin film layer and an adhesive layer. One side of the film F is coated with a hot-melt adhesive to form the adhesive layer.

The film F is conveyed from the film roll 231 to a nip portion of the bonding section 232.

The film detector 234 detects that the film roll 231 has been fitted into the laminating apparatus 20, and outputs the detection result to the controller 21. The controller 21 outputs the detection result to the image forming apparatus 10 via the IF section 27. The controller 11 of the image forming apparatus 10 stores, in the storage section 14, the detection result received from the laminating apparatus 20 together with the time at which the detection result was received as a fitting detection record of the film roll 231.

The bonding section 232 includes a pair of rollers. The bonding section 232 holds the sheet(s) and the film F at the nip portion formed by the pair of rollers to adhere the adhesive layer of the film F to the surface of the sheet. Thus, the sheet and the film F are bonded together. The leading end and the trailing end of the sheets are superposed by the superposing section 22, which prevent the adhesive applied to the film F from contacting anything other than the sheets on the path after the bonding section 232.

The lamination fixing section 233 fixes the film F onto the sheet(s) by applying heat and pressure to the sheet and the film F bonded together by the bonding section 232. The lamination fixing section 233 fuses the adhesive layer of the film F, adheres the fused adhesive layer to the surface of the sheet, and performs thermal compression bonding.

The separator 24 is provided on the downstream side of the laminating section 23 on the sheet conveyance path. The separator 24 separates the sheets from each other by cutting the film F between the sheets that are continuously conveyed in the state of being laminated with the film F.

FIG. 4 shows a schematic configuration of the separator 24. As illustrated in FIG. 4, in the sheet conveyance direction Y, a preceding sheet P11 and a subsequent sheet P12 are being conveyed in the state in which the trailing end of the preceding sheet P11 is superposed on the leading end of the subsequent sheet P12.

The separator 24 includes a guide member 241, a cutter 242, and a moving mechanism (not illustrated). The guide member 241 is a member extending in the width direction X orthogonal to the sheet conveyance direction Y. The movement mechanism moves the cutter 242 along the guide member 241. In practice, the guide member 241 is provided along the direction A that forms a predetermined angle θ with the width direction X of the sheets. The separator 24 inserts the cutter 242 between the preceding sheet P11 and the subsequent sheet P12.

The separator 24 moves the cutter 242 in the width direction X (in practice, the direction A) of the sheets, and cuts the film F along the edge of the trailing end of the preceding sheet P11. That is, the separator 24 cuts the film F between the sheets connected by being adhered to the film F to return the sheets to cut sheets.

The storage section 25 is a nonvolatile storage device including an HDD, an SSD and/or the like. The storage section 25 stores various programs, various data, and the like.

The conveyor 26 includes a plurality of roller pairs. The conveyor 26 conveys the sheet conveyed from the image forming apparatus 10, in the laminating apparatus 20.

The IF section 27 is an interface for data transmission and reception between the laminating apparatus 20 and the image forming apparatus 10.

As illustrated in FIG. 1, the laminating apparatus 20 includes a sheet ejection tray T11. The laminating apparatus 20 ejects the sheet having passed through the laminating apparatus 20 to the sheet ejection tray T11.

### [2. Operation of Laminating System]

Next, the operation of the laminating system 1 will be described.

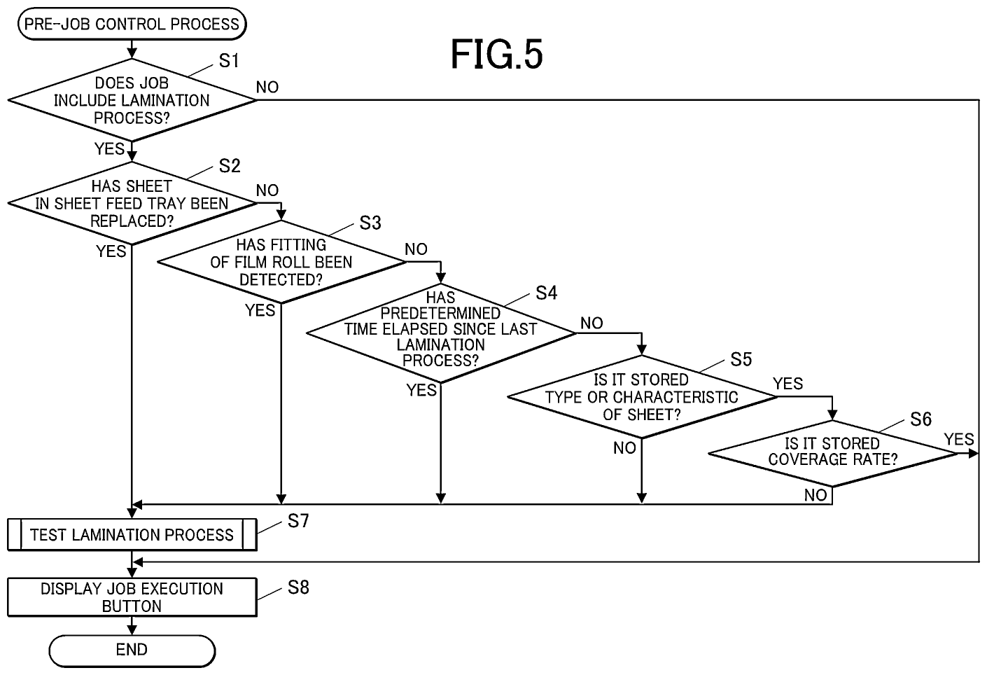

FIG. 5 is a flowchart illustrating a pre-job control process executed in the laminating system 1. The pre-job control process is implemented by software processing in cooperation between the CPU of the controller 11 of the image forming apparatus 10 and the program stored in the storage section 14.

Execution of the pre-job control process by the controller 11 of the image forming apparatus 10 can prevent consecutive failures in a lamination process in the laminating system 1.

Examples of the failure of the lamination process include occurrence of wrinkles in the laminate film, entering of air bubbles between the sheet and the laminate film, and the like.

The failure of the lamination process occurs, for example, due to a change in characteristics of the sheet caused by heating and pressurizing the sheet in the fixing section 134. The failure of the lamination process occurs, for example, due to a change in characteristics of the sheet caused by a change in the coverage rate of the image formed on the sheet. The failure of the lamination process occurs, for example, due to a change in characteristics of the sheet caused by a change in the type of the sheet. The failure of the lamination process occurs, for example, due to aging degradation of the laminate film.

The controller 11 executes the pre-job control process with acquisition of data of a job as a trigger. The controller 11 may receive the data of the job from an external apparatus via the communication part 18, or may acquire the data of the job based on an operation instruction from the operation part 152.

The data of the job includes image data of the job and setting information of the job.

The setting information of the job includes the type and size of sheets to be used in the job, information indicating the number of printed sheets, image forming conditions, and the like. When the job includes the lamination process, the setting information of the job includes information on the lamination process.

At the start of the pre-job control process, at least one of the sheet feed trays T1, T2 and T3 stores sheets to be used for a job. In addition, the film roll 231 of the film F to be used for a job is fitted to the laminating section 23.

### (Pre-job Control Process)

The controller 11 determines, based on the acquired job information, whether the job includes the lamination process (Step S1).

A case where the job includes the lamination process (Step S1; YES) will be described. In this case, the controller 11 refers to the tray setting information change record stored in the storage section 14, and determines whether or not the sheets stored in at least one of the sheet feed trays T1, T2, and T3 have been replaced by the user after the execution of the last job (Step S2).

If the sheets stored in any of the sheet feed trays have been replaced by the user after the execution of the last job (Step S2; YES), the controller 11 shifts the pre-job control process to Step S7.

A case where the sheets have not been replaced by the user after the execution of the last job (Step S2; NO) will be described. In this case, the controller 11 refers to the fitting detection record of the film roll 231 stored in the storage section 14, and determines whether or not fitting of the film roll 231 has been detected after the execution of the last job (Step S3).

If the fitting of the film roll 231 has been detected after the execution of the last job (Step S3; YES), the controller 11 shifts the pre-job control process to Step S7. The case where fitting of the film roll 231 has been detected is, for example, a case where the film roll 231 has been replaced by the user.

A case where the fitting of the film roll 231 has not been detected after the execution of the last job (Step S3; NO) will be described. In this case, the controller 11 determines whether a predetermined time has elapsed since the execution of the last lamination process by the laminating apparatus 20 (Step S4). The predetermined time varies depending on the type of the film F, and is a time in which the film F may deteriorate over time if the film F is left without the limitation process.

If the predetermined time has elapsed since the execution of the last lamination process (Step S4; YES), the controller 11 shifts the pre-job control process to Step S7.

A case where the predetermined time has not elapsed since the execution of the last lamination process (Step S4; NO) will be described. In this case, the controller 11 causes the medium detectors 171, 172, and 173 to detect the characteristics of the sheets stored in the sheet feed trays T1, T2, and T3. Next, the controller 11 determines whether the detected characteristics of the sheets are included in the test lamination information stored in the storage section 14 (Step S5). Alternatively, the controller 11 determines the type of the sheets based on the detected characteristics of the sheets, and determines whether the determined type of the sheets is included in the test lamination information stored in the storage section 14 (Step S5).

If the characteristics or the type of the sheets stored in any of the sheet feed trays T1, T2, and T3 are/is not included in the test lamination information (Step S5; NO), the controller 11 shifts the pre-job control process to Step S7.

If the sheets stored in any of the sheet feed trays has been replaced by the user after the execution of the last job (Step S2; YES), or if the characteristics of the sheets stored in any of the sheet feed trays or the type of the sheets are/is not included in the test lamination information (Step S5; NO), it is a case where sheets of a different type or characteristic from the sheets used in the previously executed job are stored in any of the sheet feed trays.

A case where the characteristics of the sheets or the types of the sheets stored in the sheet feed trays T1, T2, and T3 are included in the test lamination information (Step S5; YES) will be described. In this case, the controller 11 determines, based on the acquired job information, whether the coverage rate of a job image is included in the test lamination information stored in the storage section 14 (Step S6).

If the coverage rate of the job image is not included in the test lamination information (Step S6; NO), the controller 11 shifts the pre-job control process to Step S7.

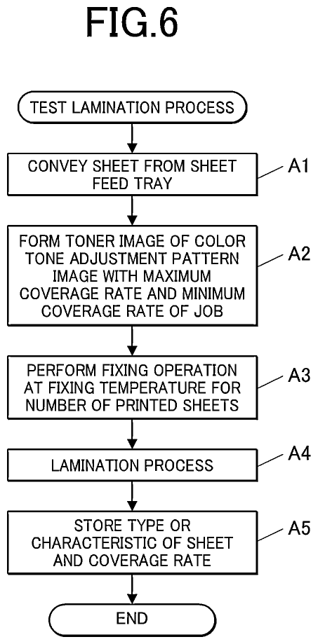

After Steps S2, S3, S4, S5 and S6, the controller 11 executes the test lamination process illustrated in FIG. 6 (Step S7).

### (Test Lamination Process)

The controller 11 causes the conveyor 16 to convey the sheets stored in the respective sheet feed trays T1, T2, and T3 to the image forming section 13 (Step A1). If the sheets stored in any one of the sheet feed trays have been replaced by the user after the execution of the last job (Step S2; YES), in Step A1, the controller 11 conveys sheets only from the sheet feed tray(s) where sheets have been replaced.

Next, the controller 11 causes the image forming section 13 to form a toner image of the color tone adjustment pattern image on sheets supplied from the sheet feed tray(s) T1, T2, and/or T3 (Step A2).

In Step A2, controller 11 changes the coverage rate of the image to be formed by the image forming section 13. Specifically, the controller 11 forms the toner image of the color tone adjustment pattern image at the maximum coverage rate and the minimum coverage rate in the job image based on the acquired data of the job. In Step A2, the controller 11 may form the toner image of the color tone adjustment pattern image at least one of the maximum coverage rate and the minimum coverage rate in the job image.

In Step A2, the controller 11 may change the coverage rate of the image to be formed on each sheet by the image forming section 13, or may change the coverage rate of the image to be formed on one sheet by the image forming section 13.

Next, the controller 11 causes the fixing section 134 of the image forming section 13 to fix the toner image formed in Step A2 onto the sheet (Step A3). In Step A3, the controller 11 performs the fixing operation at a fixing temperature for the number of printed sheets on the basis of the acquired setting information of the job. When printing is continuously performed by the image forming section 13, the temperature of the fixing section 134 decreases. Therefore, the controller 11 performs, for each sheet, the fixing operation at least at the fixing temperature at the time of printing of the first sheet and at the fixing temperature when the temperature of the fixing section 134 has decreased due to continuous printing of the maximum number of printed sheets included in the setting information of the job.

Next, the controller 11 controls the controller 21 to laminate the image-formed sheet with the film F, namely, performs the lamination process, and output the laminated sheet (output product) to the sheet ejection tray T11 (Step A4).

The user checks whether or not a failure due to wrinkling of the film or entering of air bubbles between the sheet and the film has occurred in the output product output to the sheet ejection tray T11. If no failure has occurred, the user makes an instruction, through the operation part 152, to store the type of the sheet or the characteristics of the sheet used in the test lamination process and the coverage rate of the image formed on the sheet.

Based on the instruction operation by the user, the controller 11 causes the storage section 14 to store, as test lamination information, the type or characteristics of the sheet and the coverage rate of the image formed on the sheet with no failure occurred (Step A5), and ends the test lamination process.

Referring back to FIG. 5, the controller 11 causes the display part 151 to display a job execution button, which is means (element) to make an instruction to execute a job (Step S8) and ends the pre-job control process.

If the job does not include the lamination process (Step S1; NO), or if the coverage rate of the job image is included in the test lamination information (Step S6; YES), the controller 11 shifts the pre-job control process to Step S8. That is, in this case, the test lamination process is not performed.

In the test lamination process described above, the controller 11 may omit Step A2. In this case, in Step A3, the controller 11 causes the fixing section 134 to perform the fixing operation on the sheet on which no toner image has been formed.

In Step A2 of the test lamination process, the controller 11 may cause the image forming section 13 to form a toner image other than the color tone adjustment pattern image on the sheet.

### [3. Effects]

As described above, the laminating system 1 of the present embodiment includes the image forming section 13 that forms an image on a sheet.

The laminating system 1 of the present embodiment includes the laminating section 23 that is provided on the downstream side of the image forming section 13 and performs the lamination process of laminating a sheet with the film F.

The laminating system 1 of the present embodiment includes the controller 11 that performs, before execution of a job, the test lamination process of causing the laminating section 23 to laminate a sheet with no image formed or a sheet with a test image formed by the image forming section 13, the test image being different from an image of the job.

Thus, the user can check, before execution of a job, whether or not a failure will occur in the lamination process. Therefore, continuous occurrence of failures in the lamination process can be prevented.

In the laminating system 1 of the present embodiment, the controller 11 changes the coverage rate of the image that is formed by the image forming section 13 in the test lamination process.

When the coverage rate of the image that is formed on the sheet changes, the characteristic of the sheet also changes. Thus, the user can check, before execution of a job, whether or not a failure will occur in the lamination process when the coverage rate changes.

In the laminating system 1 of the present embodiment, the controller 11 causes, in the test lamination process, the image forming section 13 to form the image on the sheet with one or both of the maximum coverage rate and the minimum coverage rate in the image of the job.

Thus, the user can check, before execution of a job, whether or not a failure will occur when a sheet with an image of a job formed is subjected to the lamination process.

In the laminating system 1 of the present embodiment, the test image includes a pattern image for color tone adjustment.

Thus, the test lamination process and the color tone adjustment process can be performed simultaneously.

In the laminating system 1 of the present embodiment, the controller 11 performs the test lamination process in the case where the job includes the lamination process.

Thus, the user can check, before execution of a job, whether or not a failure will occur in the lamination process included in the job.

The laminating system 1 of the present embodiment includes the sheet feed section 17 that feeds a sheet(s) to the image forming section 13.

In the laminating system 1 of the present embodiment, the controller 11 performs the test lamination process in the case where a sheet different in type or characteristic from a sheet used in a previously executed job is stored in the sheet feed section 17.

Thus, the user can check, before execution of a job, whether or not a failure will occur in the lamination process using a sheet different in type or characteristic from a sheet(s) used in the previously executed job.

The laminating system 1 of the present embodiment includes the medium detectors 171, 172 and 173 that detect the characteristics of the sheet(s) stored in the sheet feed section 17.

In the laminating system 1 of the present embodiment, the controller 11 executes the test lamination process in the case where the characteristic of the sheet detected by the medium detector 171, 172 or 173 is different from the characteristic of a sheet with no failure occurred in the test lamination process, or in the case where the type of the sheet determined based on the characteristic of the sheet detected by the medium detector 171, 172 or 173 is different from the type of the sheet with no failure occurred in the test lamination process.

Thus, the user can check, before execution of a job, whether or not a failure will occur in the lamination process using a sheet other than a sheet about which it has been checked that a failure does not occur in the past test lamination process.

In the laminating system 1 of the present embodiment, the controller 11 performs the test lamination process in the case where the sheet stored in the sheet feed section 17 has been replaced after execution of the last job.

Thus, the user can check, before execution of a job, whether or not a failure will occur in the lamination process using a post-replacement sheet.

In the laminating system 1 of the present embodiment, the controller 11 performs the test lamination process in the case where a predetermined time has elapsed since the last lamination process by the laminating section 23.

Thus, the user can check, before execution of a job, whether or not a failure due to aging degradation of a laminate film will occur in the lamination process.

The laminating section 23 of the laminating system 1 of the present embodiment includes the film detector 234 that detects fitting of a film to the laminating section 23.

In the laminating system 1 of the present embodiment, the controller 11 performs the test lamination process in the case where the film detector 234 detects the fitting of the film F after execution of the last job.

Thus, the user can check, before execution of a job, whether or not a failure will occur in the lamination process using a post-replacement lamination film.

The image forming section 13 of the laminating system 1 of the present embodiment includes the fixing section 134 that fixes a toner image to the sheet.

In the laminating system 1 of the present embodiment, the sheet with no image formed includes a sheet subjected to the fixing operation by the fixing section 134 with no toner image formed.

Thus, the user can check, before execution of a job, whether or not a failure will occur in the lamination process using a sheet whose characteristic(s) have been changed by being heated and pressurized by the fixing section 134.

The image forming section 13 of the laminating system 1 of the present embodiment includes the fixing section 134 that fixes a toner image to the sheet.

In the laminating system 1 of the present embodiment, the controller 11 sets the fixing temperature of the fixing section 134 in the test lamination process in accordance with the setting information of the job.

Thus, the user can check, before execution of the job, whether or not a failure will occur in the lamination process using a sheet whose characteristic(s) have been changed by being heated at the fixing temperature for the setting information of the job.

The image forming section 13 of the laminating system 1 of the present embodiment includes the fixing section 134 that fixes a toner image to the sheet.

In the laminating system 1 according to the present embodiment, the controller 11 sets the fixing temperature of the fixing section 134 in the test lamination process in accordance with the number of printed sheets of the job.

Thus, the user can check, before execution of a job, whether or not a failure will occur in the lamination process using a sheet that has been heated at the fixing temperature for the number of printed sheets of the job and whose characteristic(s) have been changed thereby.

In the laminating system 1 of the present embodiment, the controller 11 causes the display part 151 to display the element to make an instruction to execute a job after completion of the test lamination process.

Thus, the user can make an instruction to execute a job after checking whether or not a failure will occur in the lamination process.

Those described in the above embodiment are examples of the laminating system and the program stored in the storage medium according to the present invention, and the present invention is not limited thereto. The detailed configuration and detailed operation of each apparatus constituting the system can also be appropriately changed without departing from the scope of the present invention.

Although the controller 11 of the image forming apparatus 10 performs the pre-job control process in the above embodiment, the controller 21 of the laminating apparatus 20 may perform the pre-job control process.

In the above-described embodiment, the controller 11 that controls the image forming apparatus 10 and the controller 21 that controls the laminating apparatus 20 are separately provided in the laminating system 1, but it is not limited thereto. The laminating system 1 may include a controller that controls both the image forming apparatus 10 and the laminating apparatus 20. In this case, the controller that controls the laminating system 1 performs the pre-job control process.

The laminating apparatus 20 may include, on the downstream side of the separator 24, an image reading section that reads the sheets after being separated by the separator 24. In this case, the controller that controls the laminating system 1 may determine, based on the images read by the image reading section, whether the sheets separated by the separator 24 are good products or defective products.

The computer-readable medium that stores the program for executing each process is not limited to the above-described examples. As the computer-readable medium that stores the program, a portable recording medium such as a CD-ROM may be applied. Furthermore, a carrier wave may be used as a medium for providing data of the program via a communication line.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-200833, filed on Nov. 28, 2023, including description, claims, drawings and abstract is incorporated herein by reference.

What is claimed is:

1. A laminating system comprising:
an image former that forms an image on a sheet;
a laminator that is provided on a downstream side of the image former and performs a lamination process of laminating the sheet with a film; and
a hardware processor that performs, before execution of a job, a test lamination process of causing the laminator to laminate a sheet with no image formed or a sheet with a test image formed by the image former, the test image being different from an image of the job.

2. The laminating system according to claim 1, wherein the hardware processor changes a coverage rate of the test image that is formed by the image former in the test lamination process.

3. The laminating system according to claim 1, wherein the hardware processor causes, in the test lamination process, the image former to form the test image on the sheet with one or both of a maximum coverage rate and a minimum coverage rate in the image of the job.

4. The laminating system according to claim 1, wherein the test image includes a pattern image for color tone adjustment.

5. The laminating system according to claim 1, wherein the hardware processor performs the test lamination process in a case where the job includes the lamination process.

6. The laminating system according to claim 1, comprising a sheet feeder that feeds a sheet to the image former,
wherein the hardware processor performs the test lamination process in a case where a sheet different in type or characteristic from a sheet used in a previously executed job is stored in the sheet feeder.

7. The laminating system according to claim 6, comprising a medium detector that detects a characteristic of the sheet stored in the sheet feeder,
wherein the hardware processor performs the test lamination process in a case where the characteristic of the sheet detected by the medium detector is different from a characteristic of a sheet with no failure occurred in the test lamination process or in a case where a type of the sheet determined based on the characteristic of the sheet detected by the medium detector is different from a type of the sheet with no failure occurred in the test lamination process.

8. The laminating system according to claim 6, wherein the hardware processor performs the test lamination process in a case where the sheet stored in the sheet feeder has been replaced after execution of a last job.

9. The laminating system according to claim 1, wherein the hardware processor performs the test lamination process in a case where a predetermined time has elapsed since a last lamination process by the laminator.

10. The laminating system according to claim 1,
wherein the laminator includes a film detector that detects fitting of a film to the laminator, and
wherein the hardware processor performs the test lamination process in a case where the film detector has detected the fitting of the film after execution of a last job.

11. The laminating system according to claim 1,
wherein the image former includes a fixer that fixes a toner image to the sheet, and
wherein the sheet with no image formed includes a sheet subjected to a fixing operation by the fixer with no toner image formed.

12. The laminating system according to claim 1,
wherein the image former includes a fixer that fixes a toner image to the sheet, and
wherein the hardware processor sets a fixing temperature of the fixer in the test lamination process in accordance with setting information of the job.

13. The laminating system according to claim 1,
wherein the image former includes a fixer that fixes a toner image to the sheet, and
wherein the hardware processor sets a fixing temperature of the fixer in the test lamination process in accordance with the number of printed sheets of the job.

14. The laminating system according to claim 1, wherein the hardware processor causes a display to display an element to make an instruction to execute the job after completion of the test lamination process.

15. A non-transitory computer-readable storage medium storing a program causing, of a laminating system including an image former that forms an image on a sheet and a laminator that is provided on a downstream side of the image former and performs a lamination process of laminating the sheet with a film, a computer to:
perform, before execution of a job, a test lamination process of causing the laminator to laminate a sheet with no image formed or a sheet with a test image formed by the image former, the test image being different from an image of the job.
